(19) United States
(12) Patent Application Publication
(10) Pub. No.: US 2005/0225586 A1
(43) Pub. Date: Oct. 13, 2005

(54) Method and apparatus for mitigating the effects of printer dot placement errors

(76) Inventor: James M. Brenner, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/822,195

(22) Filed: Apr. 8, 2004

(51) Int. Cl. B41J 29/393

(52) U.S. Cl. 347/19

(57) ABSTRACT

A method for mitigating the effects of printer dot placement errors includes analyzing colors in an image to determine, for different printing orientations of the image, a likelihood of a printer generating a printout of the image that has a visible defect caused by dot placement errors, and selecting a printing orientation for the image depending upon the likelihood.

### BACKGROUND OF THE INVENTION

Many printers include paper handling mechanisms for advancing pieces of media during the printing process. Dot placement errors can sometimes be caused by imperfect handling of pieces of media by such mechanisms. Dot placement errors, in turn, sometimes result in printing errors. It would be desirable to be able to mitigate such effects of printer dot placement errors.

### BRIEF DESCRIPTION OF THE DRAWINGS

Detailed description of embodiments of the invention will be made with reference to the accompanying drawings:

FIG. 1 shows a printer and a piece of media upon which is printed an image with a bottom-of-form transition error that is visible;

FIG. 1A indicates a portion image in FIG. 1 that is susceptible to the effects of dot placement errors;

FIG. 2 shows a printer configured according to an example embodiment of the present invention and a piece of media upon which is printed an image with a bottom-of-form transition error that is not visible;

FIG. 3 shows a media handling system according to an example embodiment of the present invention;

FIG. 4 shows a method for mitigating the effects of printer dot placement errors according to an example embodiment of the present invention;

FIG. 5 shows a portion of an image that includes white space and dots printed thereover; and

FIG. 6 shows an example of how dot placement errors can influence the printing of dots in an image.

### DETAILED DESCRIPTION

The following is a detailed description for carrying out the invention. This description is not to be taken in a limiting sense, but is made merely for the purpose of illustrating the general principles of the invention.

According to the present invention, it has been observed that the susceptibility of a printer to the effects (e.g., printing errors) of dot placement errors is dependent upon the colors existing in image areas where the dot placement errors occur. In an example embodiment, a method for mitigating the effects of printer dot placement errors includes analyzing colors in an image to determine a likelihood of a printer generating a printout of the image that has a visible defect caused by dot placement errors, and determining whether the likelihood is sufficiently high to change an orientation of the image to be printed by the printer. In another example embodiment, a method for mitigating the effects of printer dot placement errors includes analyzing colors in an image to determine, for different printing orientations of the image, a likelihood of a printer generating a printout of the image that has a visible defect caused by dot placement errors, and selecting a printing orientation for the image depending upon the likelihood.

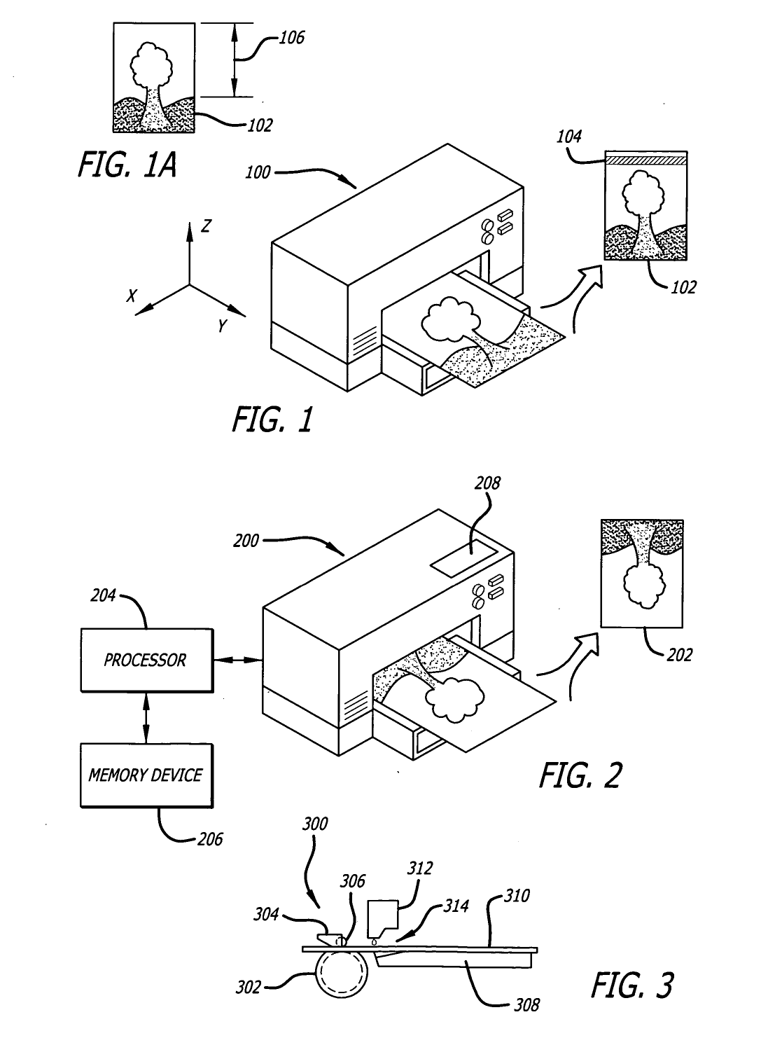

Referring to FIG. 1, a printer 100 is shown printing a piece of media 102 with an image that has a visible band 104 caused by a bottom-of-form transition error (BOFTE). In this example, in some instances, the printer 100 is susceptible to printing visible image defects resulting from dot placement errors. In this example, and referring to FIG. 1A, the image has a region 106 where color contrasts make the printer 100 susceptible to the effects of dot placement errors. According to the present invention, the susceptibility of a given printer to printing visible image defects resulting from dot placement errors can be characterized and used to mitigate the effects of dot placement errors. In various embodiments, the susceptibility of a printer to printing visible image defects resulting from dot placement errors depends upon the locations and colors of dots in a particular image. For example, some printers are more susceptible than other printers to the effects of dot placement errors when the dot placement errors are located in a portion of an image that includes a particular color, range or colors, color contrast, color transition, etc.

In various embodiments, the susceptibility of a printer to printing visible image defects resulting from dot placement errors depends upon other printer specific characteristics, such as a distance between a printer component (such as a component of a media handling mechanism) and a print zone of the printer. Referring to FIG. 3, an example embodiment of a media handling system 300 for a printer includes a drive shaft 302, a media guide 304, a set of pinch rollers 306 and a platen 308, configured as shown. The platen 308 receives a media sheet 310 upon exiting the “pinch” between the drive shaft 82 and the set of pinch rollers 306. Pens 312 are positioned over a print zone 314 as shown.

In the example of FIGS. 1 and 1A, dot placement errors result from imperfections in operation of a media handling system of the printer 100 (such as the media handling system 300). Line feed errors (along the x-axis and y-axis) and pen-to-media spacing errors (along the z-axis) can both be sources of dot placement errors. According to various embodiments of the present invention, the susceptibility of a printer to printing visible image defects resulting from dot placement errors depends upon a distance between a pinch point (e.g., in FIG. 3, where the drive shaft 302 and the set of pinch rollers 306 pinch the piece of media 310) and the print zone 314 of the printer. It should be appreciated that a pinch point can also be defined by other printer components, such as a drive shaft and a star wheel. According to various embodiments of the present invention, the susceptibility of a printer to printing visible image defects resulting from dot placement errors depends upon a distance between the pens 312 and the piece of media 310, i.e., pen-to-media spacing. Moreover, the susceptibility of a printer to printing visible image defects resulting from dot placement errors can also depend upon ink dispensing capabilities and other characteristics of the pens 312.

In various embodiments, the susceptibility of a printer to printing visible image defects resulting from dot placement errors depends upon other printer specific characteristics, such as a type of media upon which the image is to be printed. For example, some printers are more susceptible than other printers to printing visible image defects when photo media is used.

In the example of FIGS. 1 and 1A, dot placement errors occur at the bottom of the form, i.e., the last part to be printed, and the image is oriented such that the region of susceptibility 106 is at the bottom of the form. Consequently, the printer 100 may be susceptible to printing visible image defects resulting from dot placement errors (such as the visible band 104). Various embodiments of the present invention mitigate the problem of bottom of form transition errors by taking into consideration a susceptibility of a printer to printing visible image defects resulting from dot placement errors. By way of example, the susceptibility is characterized for a particular printer as a function of tone contrasts, positions of dots in an image, a distance between a pinch point and a print zone of the printer, a distance between a pen of the printer and a piece of media to be printed upon by the printer, print media type, and/or a quality level at which the image is to be printed by the printer.

FIG. 2 shows a printer 200 configured according to an example embodiment of the present invention and a piece of media 202 upon which is printed an image with a bottom-of-form transition error that is not visible. In this example, the printer 200 includes (or is provided with access to) a processor 204 and a memory device 206. By way of example, the memory device 206 stores a machine-readable program that, when executed by the processor 204, enables the printer 200 to analyze colors in an image to determine, for different printing orientations of the image, a likelihood of the printer generating a printout of the image that has a visible defect caused by dot placement errors, and select a printing orientation for the image depending upon the likelihood. According to another example embodiment of the present invention, a method for mitigating the effects of printer dot placement errors includes providing access to a machine-readable program that, when executed, enables a processor to analyze colors in an image to determine, for different printing orientations of the image, a likelihood of a printer generating a printout of the image that has a visible defect caused by dot placement errors, and select a printing orientation for the image depending upon the likelihood. In various embodiments, the processor 204 and/or the memory device 206 provide print driver functionality for the printer 200.

According to an example embodiment of the present invention, a printer with mitigated susceptibility to the effects of dot placement errors includes a mechanism for printing an image in response to image data, and a processor configured to generate the image data. By way of example, the printing mechanism can be an inkjetting mechanism or any pen. In this example, the processor is configured to access a characterization of susceptibilities of a printer to printing images with visible defects resulting from dot placement errors. The processor is also configured to analyze color tones in an image in consideration of the characterization to determine, for a plurality of image printing orientations, a likelihood of the printer generating a printout of the image that has a visible defect resulting from dot placement errors, and to identify an image printing orientation for the printer that lessens the likelihood. In the example shown in FIG. 2, the image is shown rotated 180° (compared to the image in FIG. 1) and printed without a visible band caused by a BOFTE. In this example, the image 202 was analyzed and an orientation of the image was selected such that a dot placement error would have a lower likelihood of resulting in a visible band or other defect in the printed image. As shown, the selected orientation of the image 202 results in the portion of the image that is sensitive to dot placement errors being printed at the top of the form. Although FIGS. 1 and 2 show two different image printing orientations, it should be appreciated that the principles of the present invention are applicable to analyzing and selecting from a greater number of possible image printing orientation. By way of example, four different image printing orientations (0° rotation, 90° rotation, 180° rotation, and 270° rotation) can be considered.

According to an example embodiment of the present invention, an apparatus for mitigating the effects of printer dot placement errors includes a mechanism for analyzing colors in an image to determine, for different printing orientations of the image, a likelihood of a printer generating a printout of the image that has a visible defect caused by dot placement errors, and for selecting a printing orientation for the image depending upon the likelihood, and a printer configured to print the image according to the printing orientation selected. In the example shown in FIG. 2, the printer 200 is configured with a user interface 208 (such as a touch screen) that allows a user of the printer 200 to make inputs. For example, the printer 200 can be configured to provide—via the user interface 208—an indication of the likelihood of the printer generating a printout of an image that has a visible defect caused by dot placement errors for one or more image printing orientations. According to an example embodiment of the present invention, an apparatus for mitigating the effects of printer dot placement errors includes a mechanism for analyzing colors in an image to determine, for different printing orientations of the image, a likelihood of a printer generating a printout of the image that has a visible defect caused by dot placement errors, and for providing an indication of the likelihood in relation to the different printing orientations, and a printer configured to allow a user of the printer to select a printing orientation for the image in response to the indication and to print the image according to the printing orientation selected.

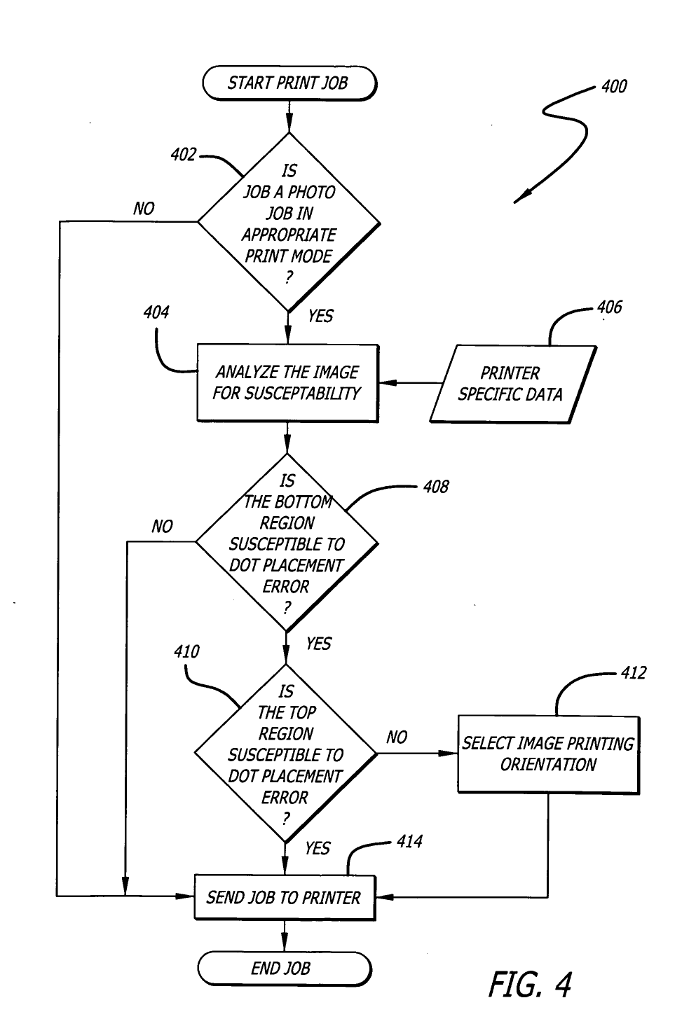

Referring to FIG. 4, an example embodiment of a method 400 for mitigating the effects of printer dot placement errors includes, at step 402, determining whether a started print job includes an image (e.g., a photographic image). If the determination is affirmative, at step 404, the image to be printed is analyzed for susceptibilities to printing image defects resulting from dot placement errors. This analysis step 404 is undertaken in consideration of printer specific data 406. In various embodiments, the susceptibilities depend upon one or more of the following: a range of color values in the image, tone contrasts in the image, one or more colors in the image, and one or more color transitions in the image. For example, some printers are particularly susceptible to the effects of dot placement errors when printing specific colors such as light blues and light pinks, when printing particular ranges of RGB values, and/or when printing certain tone contrasts; such susceptibilities are characterized for the printer and included in its printer specific data 406. In an example embodiment, such colors are identified during development by the relationship of input RGB values to output KCMY values as created by color mapping routines used by the printer.

In an example case, each pixel is represented by a 24 bit value comprised of 8 bits each for Red, Green, and Blue (RGB) in the driver. These RGB color values are in an additive color space. The printer converts these into a subtractive color space comprised of 8 bits each of Cyan, Magenta, Yellow, and sometimes 1 bit Black (CMYK). This CMYK color space is further processed (halftoned) into discrete units and ultimately into drops of color and printed on the media (e.g., paper or photo based film).

The conversion of RGB to CMYK is dependent on various printer specific factors. Examples of these factors are: the actual hue of the CMYK inks, the chemistry of the inks (absorption, evaporation, mixing, etc), the manner in which they are applied to the media, the size of the ink drops, the speed in which the ink drops are applied, the desired quality level, and the order in which the inks are applied.

The RGB space can also be converted into more than 4 inks, for example, 6 inks such as Cyan, Light Cyan, Magenta, Light Magenta, Yellow, and Black (CcMmYK). The mapping of RGB to the target color space (Color Map) is dependent on the particulars of the printing system. In the resulting color space, there may be RGB colors that result in a pattern of dots on the media with even spacing of color and white-space. For some printers, such regions are particularly susceptible to dot placement errors. By way of example, a range of RGB values that results in this sensitivity is part of the printer specific data 406.

In various embodiments, a print driver (or other “analyzer”) is used to inspect RGB values near both ends of the image, where a transition error is likely to fall. The driver software then determines which end of the image is less susceptible to dot placement error based on the sensitivities characterized during development. Once determined, the driver then rotates the image appropriately, thereby minimizing the effect of the dot placement error. In various embodiments, the driver is used to inspect the RGB values in the regions where the media is moving into and out of pinch against a range of RGB values known to be sensitive to dot placement. Since the pinch point is generally at the bottom of the page where the media is released from the pinch point, if a likelihood of the printer printing the image with image defects can be lessened, then the driver rotates the image to a different image printing orientation which puts the line feed error into a less sensitive portion of the image.

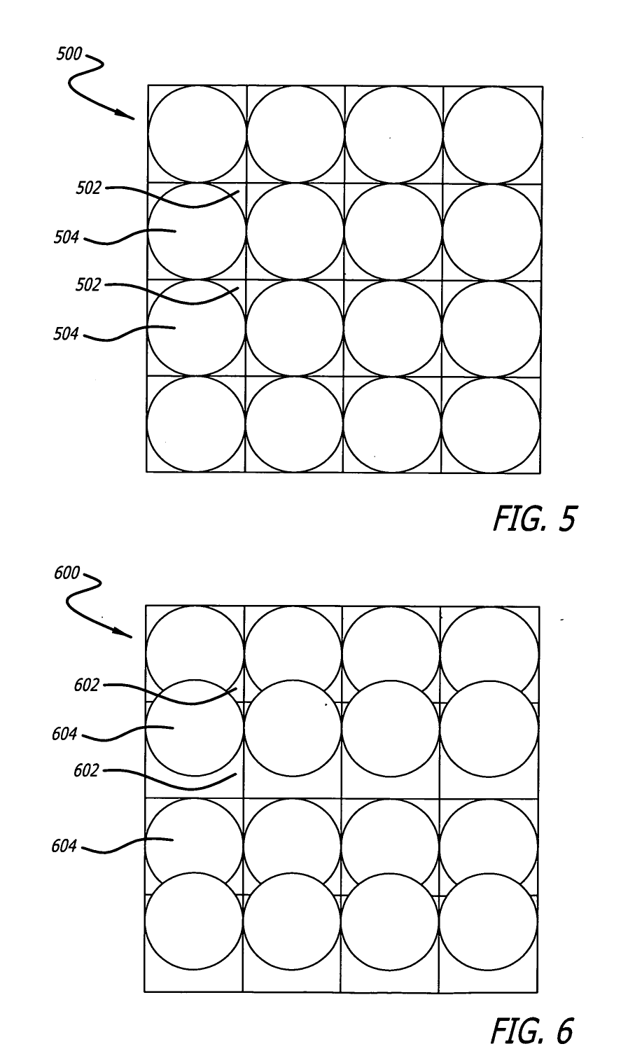

Referring to FIGS. 5 and 6, the susceptibilities can also depend upon spatial relationships between color dots and white spaces in the image. FIG. 5 shows a portion of an image 500 that includes white space 502 and dots 504. In this example, there are no dot placement errors that shift the positions of the dots 504, and the dots are shown as being perfectly round (typically not the case in practical implementations). In this example, there is about 21% white space uniformly distributed throughout the image 500. FIG. 6 shows a portion of an image 600 that includes white space 602 and dots 604. In this example, dot placement errors cause the dots 604 to overlap as shown. The dot placement errors result in the white space 602 covering a higher percentage of the image 600 than in the example described with reference to FIG. 5. In various embodiments of the present invention, the susceptibilities depend upon positions of color dots that form the image on the piece of media, a percentage of a fill area in the image that is white space, and/or an amount of overlap between a fill area in the image and dots adjacent to the fill area. By way of example, an amount of white space in an image area can be measured using a scanner or other imaging device of the printer. Solid fill areas are typically less sensitive to dot placement errors than fill areas where edges of dots barely overlap and white space is mixed (e.g., at about 50%) relative to color dots. By way of example, such a mixture of white space and cyan color dots can result in a printing pattern that makes some printers susceptible to printing visible image defects resulting from dot placement errors.

The susceptibilities can also depend upon a desired print mode that designates, for example, a media type upon which the image is to be printed by the printer and/or a quality level at which the image is to be printed by the printer.

The susceptibilities can also depend upon a distance between a component of the printer (e.g., a pinch roller or a pen) and a print zone of the printer, a distance between a pinch point and a print zone of the printer, and/or a distance between a pen of the printer and a piece of media to be printed upon by the printer. In various embodiments, the physical relation between the pinch points and the print zone is measured and characterized for a given mechanical design. This information can also be part of the printer specific data 406.

At steps 408 and 410, in this example method, if it is determined that the top region of the image is susceptible to dot placement errors, then a different image printing orientation is selected at step 412 and the job is sent to the printer at step 414. For example, at step 412, the image printing orientation is rotated 180° (or some other amount) in relation to an original image printing orientation.

According to an example embodiment of the present invention, a method for mitigating the effects of printer dot placement errors includes determining contrasts in image colors that cause a printer to print images with visible defects resulting from dot placement errors and, for each of a plurality of image printing orientations for an image, identifying regions of the image where dot placement errors can occur when using the printer to print the image. By way of example, the step of determining contrasts includes taking into consideration a distance between a component of the printer and a print zone of the printer, a distance between a pinch point and a print zone of the printer, a distance between a pen of the printer and a piece of media to be printed upon by the printer, a media type upon which the image is to be printed by the printer, and/or a quality level at which the image is to be printed by the printer. The method also includes analyzing the image to determine an incidence of the contrasts in the regions identified for each of the image printing orientations, and selecting an image printing orientation with a lowest incidence of contrasts that are likely to cause the printer to generate a printout of the image that has a visible defect resulting from dot placement errors. By way of example, the step of analyzing the image includes comparing the image colors of adjacent image pixels and/or the image colors along a feed direction of the printer.

According to another example embodiment of the present invention, a method for mitigating the effects of printer dot placement errors includes providing a characterization of susceptibilities of a printer to printing images with visible defects resulting from dot placement errors, and analyzing color tones in an image in consideration of the characterization to determine, for a plurality of image printing orientations, a likelihood of the printer generating a printout of the image that has a visible defect resulting from dot placement errors. In another embodiment, the method further includes selecting an image printing orientation for the printer that lessens the likelihood. By way of example, selecting an image printing orientation includes selecting from one of two image printing orientations that are rotated 180 degrees relative to each other.

Although the present invention has been described in terms of the example embodiments above, numerous modifications and/or additions to the above-described embodiments would be readily apparent to one skilled in the art. It is intended that the scope of the present invention extends to all such modifications and/or additions.

1. A method for mitigating the effects of printer dot placement errors comprising:
providing a characterization of susceptibilities of a printer to printing images with visible defects resulting from dot placement errors; and
analyzing color tones in an image in consideration of the characterization to determine, for a plurality of image printing orientations, a likelihood of the printer generating a printout of the image that has a visible defect resulting from dot placement errors.

2. The method for mitigating the effects of printer dot placement errors of claim 1, further comprising:
selecting an image printing orientation for the printer that lessens the likelihood.

3. The method for mitigating the effects of printer dot placement errors of claim 2, wherein selecting an image printing orientation includes selecting from one of two image printing orientations that are rotated 180 degrees relative to each other.

4. The method for mitigating the effects of printer dot placement errors of claim 1, wherein the susceptibilities depend upon a range of color values in the image.

5. The method for mitigating the effects of printer dot placement errors of claim 1, wherein the susceptibilities depend upon tone contrasts in the image.

6. The method for mitigating the effects of printer dot placement errors of claim 1, wherein the susceptibilities depend upon one or more colors in the image.

7. The method for mitigating the effects of printer dot placement errors of claim 1, wherein the susceptibilities depend upon one or more color transitions in the image.

8. The method for mitigating the effects of printer dot placement errors of claim 1, wherein the susceptibilities depend upon a percentage of a fill area in the image that is white space.

9. The method for mitigating the effects of printer dot placement errors of claim 1, wherein the susceptibilities depend upon spatial relationships between color dots and white spaces in the image.

10. The method for mitigating the effects of printer dot placement errors of claim 1, wherein the susceptibilities depend upon an amount of overlap between a fill area in the image and dots adjacent to the fill area.

11. The method for mitigating the effects of printer dot placement errors of claim 1, wherein the susceptibilities depend upon positions of color-dots that form the image on the piece of media.

12. The method for mitigating the effects of printer dot placement errors of claim 11, wherein the color dots are blue.

13. The method for mitigating the effects of printer dot placement errors of claim 11, wherein the color dots are pink.

14. The method for mitigating the effects of printer dot placement errors of claim 1, wherein the susceptibilities depend upon a distance between a component of the printer and a print zone of the printer.

15. The method for mitigating the effects of printer dot placement errors of claim 14, wherein the component is a roller.

16. The method for mitigating the effects of printer dot placement errors of claim 14, wherein the component is a pinch roller.

17. The method for mitigating the effects of printer dot placement errors of claim 14, wherein the component is a pen.

18. The method for mitigating the effects of printer dot placement errors of claim 1, wherein the susceptibilities depend upon a distance between a pinch point and a print zone of the printer.

19. The method for mitigating the effects of printer dot placement errors of claim 1, wherein the susceptibilities depend upon a distance between a pen of the printer and a piece of media to be printed upon by the printer.

20. The method for mitigating the effects of printer dot placement errors of claim 1, wherein the susceptibilities depend upon a media type upon which the image is to be printed by the printer.

21. The method for mitigating the effects of printer dot placement errors of claim 1, wherein the susceptibilities depend upon a quality level at which the image is to be printed by the printer.

22. The method for mitigating the effects of printer dot placement errors of claim 1, wherein the visible defect is a band.

23. A method for mitigating the effects of printer dot placement errors comprising:
determining contrasts in image colors that cause a printer to print images with visible defects resulting from dot placement errors;
for each of a plurality of image printing orientations for an image, identifying regions of the image where dot placement errors can occur when using the printer to print the image;
analyzing the image to determine an incidence of the contrasts in the regions identified for each of the image printing orientations; and
selecting an image printing orientation with a lowest incidence of contrasts that are likely to cause the printer to generate a printout of the image that has a visible defect resulting from dot placement errors.

24. The method for mitigating the effects of printer dot placement errors of claim 23, wherein determining contrasts includes taking into consideration a distance between a component of the printer and a print zone of the printer.

25. The method for mitigating the effects of printer dot placement errors of claim 23, wherein determining contrasts includes taking into consideration a distance between a pinch point and a print zone of the printer.

26. The method for mitigating the effects of printer dot placement errors of claim 23, wherein determining contrasts includes taking into consideration a distance between a pen of the printer and a piece of media to be printed upon by the printer.

27. The method for mitigating the effects of printer dot placement errors of claim 23, wherein determining contrasts includes taking into consideration a media type upon which the image is to be printed by the printer.

28. The method for mitigating the effects of printer dot placement errors of claim 23, wherein determining contrasts includes taking into consideration a quality level at which the image is to be printed by the printer.

29. The method for mitigating the effects of printer dot placement errors of claim 23, wherein analyzing the image includes comparing the image colors of adjacent image pixels.

30. The method for mitigating the effects of printer dot placement errors of claim 23, wherein analyzing the image includes comparing the image colors along a feed direction of the printer.

31. The method for mitigating the effects of printer dot placement errors of claim 23, wherein the visible defect is a band.

32. A method for mitigating the effects of printer dot placement errors comprising:
analyzing colors in an image to determine a likelihood of a printer generating a printout of the image that has a visible defect caused by dot placement errors; and
determining whether the likelihood is sufficiently high to change an orientation of the image to be printed by the printer.

33. The method for mitigating the effects of printer dot placement errors of claim 32, further comprising:
changing the orientation of the image.

34. The method for mitigating the effects of printer dot placement errors of claim 32, wherein analyzing colors takes into consideration a characterization of susceptibilities of the printer to printing images with visible defects resulting from dot placement errors.

35. The method for mitigating the effects of printer dot placement errors of claim 34, wherein the susceptibilities depend upon a range of color values in the image.

36. The method for mitigating the effects of printer dot placement errors of claim 34, wherein the susceptibilities depend upon tone contrasts in the image.

37. The method for mitigating the effects of printer dot placement errors of claim 34, wherein the susceptibilities depend upon one or more colors in the image.

38. The method for mitigating the effects of printer dot placement errors of claim 34, wherein the susceptibilities depend upon one or more color transitions in the image.

39. The method for mitigating the effects of printer dot placement errors of claim 34, wherein the susceptibilities depend upon a percentage of a fill area in the image that is white space.

40. The method for mitigating the effects of printer dot placement errors of claim 34, wherein the susceptibilities depend upon spatial relationships between color dots and white spaces in the image.

41. The method for mitigating the effects of printer dot placement errors of claim 34, wherein the susceptibilities depend upon an amount of overlap between a fill area in the image and dots adjacent to the fill area.

42. The method for mitigating the effects of printer dot placement errors of claim 34, wherein the susceptibilities depend upon positions of color dots that form the image on a piece of media.

43. The method for mitigating the effects of printer dot placement errors of claim 42, wherein the color dots are blue.

44. The method for mitigating the effects of printer dot placement errors of claim 42, wherein the color dots are pink.

45. The method for mitigating the effects of printer dot placement errors of claim 34, wherein the susceptibilities depend upon a distance between a component of the printer and a print zone of the printer.

46. The method for mitigating the effects of printer dot placement errors of claim 45, wherein the component is a roller.

47. The method for mitigating the effects of printer dot placement errors of claim 45, wherein the component is a pinch roller.

48. The method for mitigating the effects of printer dot placement errors of claim 45, wherein the component is a pen.

49. The method for mitigating the effects of printer dot placement errors of claim 34, wherein the susceptibilities depend upon a distance between a pinch point and a print zone of the printer.

50. The method for mitigating the effects of printer dot placement errors of claim 34, wherein the susceptibilities depend upon a distance between a pen of the printer and a piece of media to be printed upon by the printer.

51. The method for mitigating the effects of printer dot placement errors of claim 34, wherein the susceptibilities depend upon a media type upon which the image is to be printed by the printer.

52. The method for mitigating the effects of printer dot placement errors of claim 34, wherein the susceptibilities depend upon a quality level at which the image is to be printed by the printer.

53. The method for mitigating the effects of printer dot placement errors of claim 32, wherein the visible defect is a band.

54. A method for mitigating the effects of printer dot placement errors comprising:
analyzing colors in an image to determine, for different printing orientations of the image, a likelihood of a printer generating a printout of the image that has a visible defect caused by dot placement errors; and
selecting a printing orientation for the image depending upon the likelihood.

55. The method for mitigating the effects of printer dot placement errors of claim 54, wherein analyzing colors takes into consideration a characterization of susceptibilities of the printer to printing images with visible defects resulting from dot placement errors.

56. The method for mitigating the effects of printer dot placement errors of claim 55, wherein the susceptibilities depend upon a range of color values in the image.

57. The method for mitigating the effects of printer dot placement errors of claim 55, wherein the susceptibilities depend upon tone contrasts in the image.

58. The method for mitigating the effects of printer dot placement errors of claim 55, wherein the susceptibilities depend upon one or more colors in the image.

59. The method for mitigating the effects of printer dot placement errors of claim 55, wherein the susceptibilities depend upon one or more color transitions in the image.

60. The method for mitigating the effects of printer dot placement errors of claim 55, wherein the susceptibilities depend upon a percentage of a fill area in the image that is white space.

61. The method for mitigating the effects of printer dot placement errors of claim 55, wherein the susceptibilities depend upon spatial relationships between color dots and white spaces in the image.

62. The method for mitigating the effects of printer dot placement errors of claim 55, wherein the susceptibilities depend upon an amount of overlap between a fill area in the image and dots adjacent to the fill area.

63. The method for mitigating the effects of printer dot placement errors of claim 55, wherein the susceptibilities depend upon positions of color dots that form the image on a piece of media.

64. The method for mitigating the effects of printer dot placement errors of claim 63, wherein the color dots are blue.

65. The method for mitigating the effects of printer dot placement errors of claim 63, wherein the color dots are pink.

66. The method for mitigating the effects of printer dot placement errors of claim 55, wherein the susceptibilities depend upon a distance between a component of the printer and a print zone of the printer.

67. The method for mitigating the effects of printer dot placement errors of claim 66, wherein the component is a roller.

68. The method for mitigating the effects of printer dot placement errors of claim 66, wherein the component is a pinch roller.

69. The method for mitigating the effects of printer dot placement errors of claim 66, wherein the component is a pen.

70. The method for mitigating the effects of printer dot placement errors of claim 55, wherein the susceptibilities depend upon a distance between a pinch point and a print zone of the printer.

71. The method for mitigating the effects of printer dot placement errors of claim 55, wherein the susceptibilities depend upon a distance between a pen of the printer and a piece of media to be printed upon by the printer.

72. The method for mitigating the effects of printer dot placement errors of claim 55, wherein the susceptibilities depend upon a media type upon which the image is to be printed by the printer.

73. The method for mitigating the effects of printer dot placement errors of claim 55, wherein the susceptibilities depend upon a quality level at which the image is to be printed by the printer.

74. The method for mitigating the effects of printer dot placement errors of claim 54, wherein the visible defect is a band.

75. A method for mitigating the effects of printer dot placement errors comprising:
providing access to a machine-readable program that, when executed, enables a processor to
analyze colors in an image to determine, for different printing orientations of the image, a likelihood of a printer generating a printout of the image that has a visible defect caused by dot placement errors, and
select a printing orientation for the image depending upon the likelihood.

76. An apparatus for mitigating the effects of printer dot placement errors comprising:
a memory device upon which is stored a machine-readable program that, when executed, enables a printer to
analyze colors in an image to determine, for different printing orientations of the image, a likelihood of the printer generating a printout of the image that has a visible defect caused by dot placement errors, and
select a printing orientation for the image depending upon the likelihood.

77. An apparatus for mitigating the effects of printer dot placement errors comprising:
means for analyzing colors in an image to determine, for different printing orientations of the image, a likelihood of a printer generating a printout of the image that has a visible defect caused by dot placement errors, and for selecting a printing orientation for the image depending upon the likelihood; and
a printer configured to print the image according to the printing orientation selected.

78. An apparatus for mitigating the effects of printer dot placement errors comprising:
means for analyzing colors in an image to determine, for different printing orientations of the image, a likelihood of a printer generating a printout of the image that has a visible defect caused by dot placement errors, and for providing an indication of the likelihood in relation to the different printing orientations; and
a printer configured to allow a user of the printer to select a printing orientation for the image in response to the indication and to print the image according to the printing orientation selected.

79. A printer with mitigated susceptibility to the effects of dot placement errors comprising:
means for printing an image in response to image data; and
a processor configured to generate the image data by
accessing a characterization of susceptibilities of a printer to printing images with visible defects resulting from dot placement errors,
analyzing color tones in an image in consideration of the characterization to determine, for a plurality of image printing orientations, a likelihood of the printer generating a printout of the image that has a visible defect resulting from dot placement errors, and
identifying an image printing orientation for the printer that lessens the likelihood.

80. The printer with mitigated susceptibility to the effects of dot placement errors of claim 79, wherein the means for printing includes a pen.

81. The printer with mitigated susceptibility to the effects of dot placement errors of claim 79, wherein the means for printing includes an inkjetting mechanism.

82. The printer with mitigated susceptibility to the effects of dot placement errors of claim 79, wherein the processor is configured to provide a print driver.

83. The printer with mitigated susceptibility to the effects of dot placement errors of claim 79, wherein the susceptibilities depend upon a range of color values in the image.

84. The printer with mitigated susceptibility to the effects of dot placement errors of claim 79, wherein the susceptibilities depend upon tone contrasts in the image.

85. The printer with mitigated susceptibility to the effects of dot placement errors of claim 79, wherein the susceptibilities depend upon one or more colors in the image.

86. The printer with mitigated susceptibility to the effects of dot placement errors of claim 79, wherein the susceptibilities depend upon one or more color transitions in the image.

87. The printer with mitigated susceptibility to the effects of dot placement errors of claim 79, wherein the susceptibilities depend upon a percentage of a fill area in the image that is white space.

88. The printer with mitigated susceptibility to the effects of dot placement errors of claim 79, wherein the susceptibilities depend upon spatial relationships between color dots and white spaces in the image.

89. The printer with mitigated susceptibility to the effects of dot placement errors of claim 79, wherein the susceptibilities depend upon an amount of overlap between a fill area in the image and dots adjacent to the fill area.

90. The printer with mitigated susceptibility to the effects of dot placement errors of claim 79, wherein the susceptibilities depend upon positions of color dots that form the image on the piece of media.

91. The printer with mitigated susceptibility to the effects of dot placement errors of claim 90, wherein the color dots are blue.

92. The printer with mitigated susceptibility to the effects of dot placement errors of claim 90, wherein the color dots are pink.

93. The printer with mitigated susceptibility to the effects of dot placement errors of claim 79, wherein the susceptibilities depend upon a distance between a component of the printer and a print zone of the printer.

94. The printer with mitigated susceptibility to the effects of dot placement errors of claim 93, wherein the component is a roller.

95. The printer with mitigated susceptibility to the effects of dot placement errors of claim 93, wherein the component is a pinch roller.

96. The printer with mitigated susceptibility to the effects of dot placement errors of claim 93, wherein the component is a pen.

97. The printer with mitigated susceptibility to the effects of dot placement errors of claim 79, wherein the susceptibilities depend upon a distance between a pinch point and a print zone of the printer.

98. The printer with mitigated susceptibility to the effects of dot placement errors of claim 79, wherein the susceptibilities depend upon a distance between a pen of the printer and a piece of media to be printed upon by the printer.

99. The printer with mitigated susceptibility to the effects of dot placement errors of claim 79, wherein the susceptibilities depend upon a media type upon which the image is to be printed by the printer.

100. The printer with mitigated susceptibility to the effects of dot placement errors of claim 79, wherein the susceptibilities depend upon a quality level at which the image is to be printed by the printer.

101. The printer with mitigated susceptibility to the effects of dot placement errors of claim 79, wherein the visible defect is a band.
